(19) United States
(12) Patent Application Publication
(10) Pub. No.: US 2019/0315276 A1
(43) Pub. Date: Oct. 17, 2019

(54) REARVIEW MIRROR APPARATUS AND CAR THEREOF

(71) Applicant: QISDA CORPORATION, Taoyuan City (TW)

(72) Inventor: Hao-Chun Tung, Kinmen County (TW)

(21) Appl. No.: 16/105,973

(22) Filed: Aug. 21, 2018

(30) Foreign Application Priority Data
Apr. 12, 2018 (CN) 201810325040.1

(51) Int. Cl. B60R 1/00; B60R 1/08; B60R 1/12

(52) U.S. Cl. CPC B60R 1/007; B60R 1/081; B60R 2001/1223; B60R 2001/1253; B60R 1/12

(57) ABSTRACT

A rearview mirror apparatus for connecting to a car includes a rearview mirror device pivoted to the car, first and second gear devices, a monitoring device, and a controller coupled to the first and second gear devices. The first gear device is connected to the rearview mirror device for rotating the rearview mirror device relative to the car. The monitoring device is pivoted to the rearview mirror device for monitoring a surrounding area of the car. The second gear device is connected to the monitoring device for rotating the monitoring device relative to the rearview mirror device. When the controller controls the first gear device to rotate the rearview mirror device by a pivoting angle, the controller controls the second gear device to rotate the monitoring device by a compensation angle according to the pivoting angle for aligning the monitoring device with the surrounding area.

### BACKGROUND OF THE INVENTION

### 1. Field of the Invention

The present invention relates to a rearview mirror apparatus and a car thereof, and more specifically, to a rearview mirror apparatus disposing a monitoring device on a rearview mirror device for rotating the monitoring device by a compensation angle according to a pivoting angle of the rearview mirror device and a car thereof.

### 2. Description of the Prior Art

In general, for efficiently preventing a car from colliding with an object (e.g. a utility pole) while the car is moving forward or backward, infrared light sensors are usually disposed on front and rear bumpers of the car and produce a warning sound when the car is too close to the object, so as to remind a driver of braking the car in time.

However, the aforesaid sensing design can only perform safety monitoring on the front and rear surrounding areas of the car (e.g. reverse monitoring) rather than the left or right surrounding area of the car. Furthermore, the driver's vision could be easily blocked by the frame structure of the car, and the left, central, right rearview mirrors of the car could only provide a narrow driving vision. Thus, the driver cannot grasp the whole situation around the car since the aforesaid problems may cause blind spot areas when the driver is driving the car. For example, since the driver's front vision could be blocked by the front window pillars of the car easily, the driver often cannot see the pedestrians at the left and right front sides of the car in time, so as to greatly influence the driving safety of the car.

### SUMMARY OF THE INVENTION

The present invention provides a rearview mirror apparatus for connecting to a car. The rearview mirror apparatus includes a first rearview mirror device, a first gear device, a first monitoring device, a second gear device, and a controller. The first rearview mirror device is pivoted to a first lateral side of the car. The first gear device is connected to the first rearview mirror device for driving the first rearview mirror device to rotate relative to the car. The first monitoring device is pivoted to the first rearview mirror device for monitoring a first surrounding area of the car. The second gear device is connected to the first monitoring device for driving the first monitoring device to rotate relative to the first rearview mirror device. The controller is electrically connected to the first gear device and the second gear device respectively. When the controller controls the first gear device to rotate the first rearview mirror device by a first pivoting angle relative to the car, the controller controls the second gear device to rotate the first monitoring device by a first compensation angle according to the first pivoting angle for aligning the first monitoring device with the first surrounding area.

The present invention further provides a car including a car body, a rearview mirror apparatus and a controller. The rearview mirror apparatus is connected to the car body. The rearview mirror apparatus includes a rearview mirror device, a first gear device, a monitoring device and a second gear device. The rearview mirror device is pivoted to a lateral side of the car body. The first gear device is connected to the rearview mirror device for driving the rearview mirror device to rotate relative to the car body. The monitoring device is pivoted to the rearview mirror device for monitoring a surrounding area of the car body. The second gear device is connected to the monitoring device for driving the monitoring device to rotate relative to the rearview mirror device. The controller is disposed in one of the car body and the rearview mirror apparatus and electrically connected to the first gear device and the second gear device respectively. When the controller controls the first gear device to rotate the rearview mirror device by a pivoting angle relative to the car body, the controller controls the second gear device to rotate the monitoring device by a compensation angle according to the pivoting angle for aligning the monitoring device with the surrounding area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a car according to an embodiment of the present invention.

FIG. 2 is a partial internal diagram of the car in FIG. 1.

FIG. 3 is an enlarged diagram of a first rearview mirror device and a first monitoring device in FIG. 1.

FIG. 4 is an enlarged diagram of a second rearview mirror device and a second monitoring device in FIG. 1.

### DETAILED DESCRIPTION

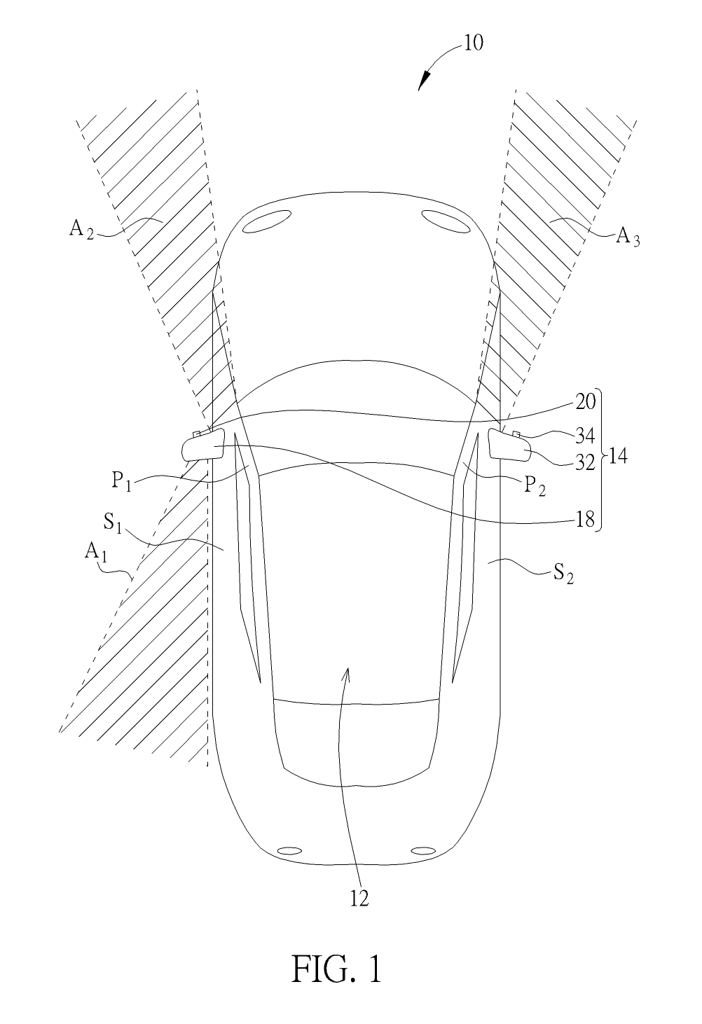

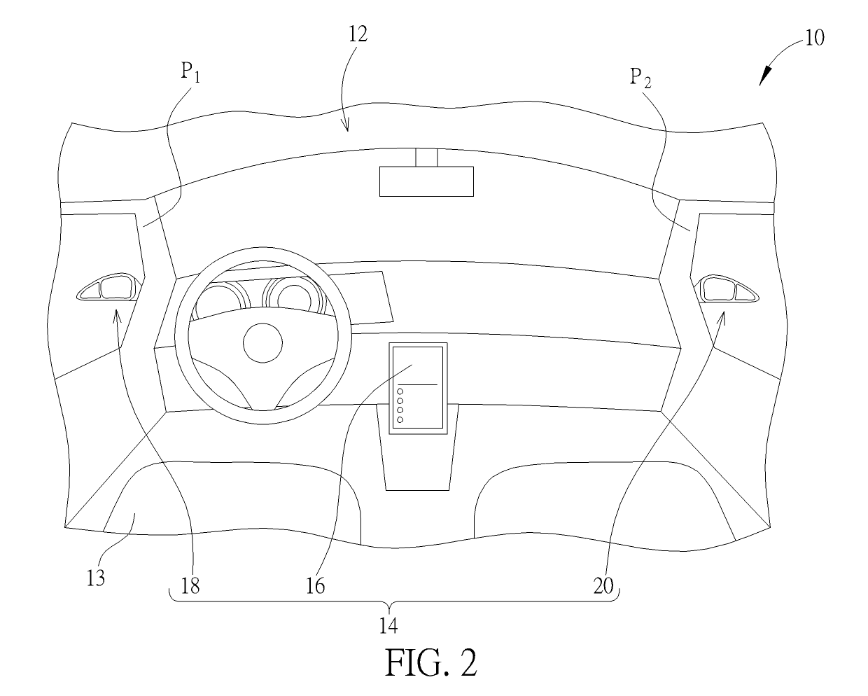

Please refer to FIG. 1 and FIG. 2. FIG. 1 is a diagram of a car 10 according to an embodiment of the present invention. FIG. 2 is a partial internal diagram of the car 10 in FIG. 1. As shown in FIG. 1 and FIG. 2, the car 10 includes a car body 12, a rearview mirror apparatus 14, and a controller 16. The car body 12 could have a first front window pillar P₁, a second front window pillar P₂, and a driver seat 13 (preferably suitable for a left-hand drive car, but not limited thereto) . The first front window pillar P₁ is adjacent to the driver seat 13, and the second front window pillar P₂ is away from the driver seat 13. As for the related description for other components (e.g. a car engine and an automobile chassis mechanism) of the car body 12, it is commonly seen in the prior art and omitted herein. The rearview mirror apparatus 14 is connected to the car body 12. The controller 16 could be preferably a control host (e.g. a car control panel) disposed in the car body 12, but not limited thereto, meaning that the present invention could adopt the design that the controller 16 (e.g. a processing chip) is directly disposed in the rearview mirror apparatus 14 for controlling the rearview mirror apparatus 14 to perform a safety monitoring operation in another embodiment.

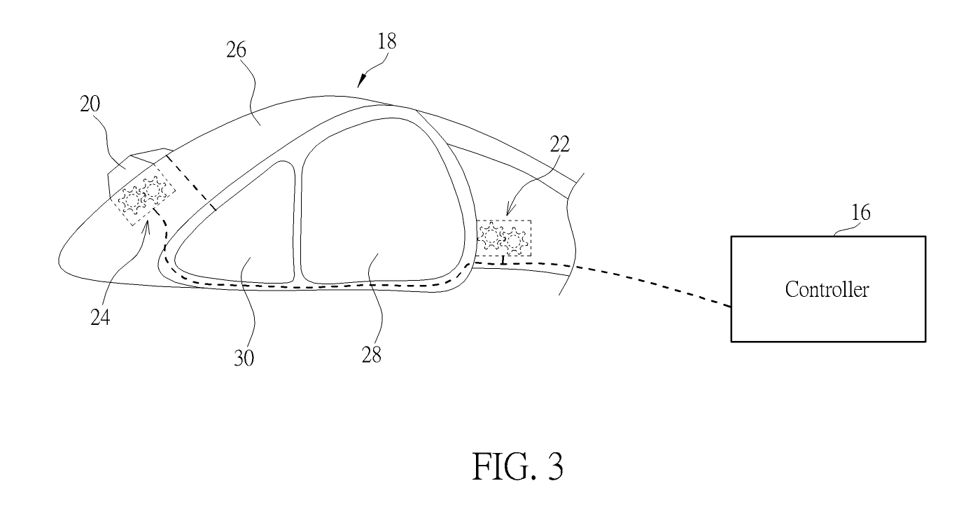

More detailed description for the rearview mirror apparatus 14 is provided as follows. Please refer to FIGS. 1-3. FIG. 3 is an enlarged diagram of a first rearview mirror device 18 and a first monitoring device 20 in FIG. 1. As shown in FIGS. 1-3, the rearview mirror apparatus 14 includes the first rearview mirror device 18, the first monitoring device 20, a first gear device 22, and a second gear device 24. The first gear device 22 and the second gear device 24 are depicted briefly by dotted lines in FIG. 3. The first rearview mirror device 18 is pivoted to a first lateral side S₁ of the car body 12. In this embodiment, the first rearview mirror device 18 could include a rearview mirror casing 26, a rearview mirror 28, and a display monitor 30. The rearview mirror casing 26 is pivoted to the first lateral side S₁ of the car body 12 and is connected to the first gear device 22. Accordingly, the first gear device 22 can drive the rearview mirror casing 26 to rotate relative to the car body 12 so that a user can flexibly adjust a pivoting angle of the rearview mirror casing 26 according to the practical driving situation. The rearview mirror 28 is disposed in the rearview mirror casing 26 to be aligned with an oblique rear area A₁ of the car body 12 for reflecting rearview images so that the user can view the oblique rear area A₁ via the rearview mirror 28 at any time for safe driving (e.g. changing lanes after the user makes sure that the car 10 is away from another car coming from behind at a safety distance) . The first monitoring device 20 could be preferably an image capturing device (e.g. a surveillance camera) and is pivoted to the rearview mirror casing 26 to be aligned with the first surrounding area A₂ of the car body 12 (preferably a blind spot area corresponding to the first front window pillar P₁) for image surveillance.

Furthermore, the first monitoring device 20 is connected to the second gear device 24. Accordingly, the second gear device 24 can drive the first monitoring device 20 to rotate relative to the rearview mirror casing 26 for flexibly adjusting the monitoring angle of the first monitoring device 20. The display monitor 30 is electrically connected to the first monitoring device 20 and is arranged alongside the rearview mirror 28 to move together with the rearview mirror 28 and the rearview mirror casing 26. The display monitor 30 is used for displaying surveillance images captured by the first monitoring device 20 toward the first surrounding area A₂ to help the user view the first surrounding area A₂ clearly. As such, the present invention can efficiently prevent the user from driving the car 10 to collide with any object (e.g. a pedestrian or a car coming from left or right) within the first surrounding area A₂ by accident when the user's vision is blocked by the first front window pillar P₁.

To be noted, the related description for the aforesaid gear driving design that the first gear device 22 drives the rearview mirror casing 26 to rotate relative to the car body 12 and the second gear device 24 drives the first monitoring device 20 to rotate relative to the rearview mirror casing 26 is omitted herein since it is commonly seen in the prior art.

Via the aforesaid design, when the controller 16 controls the first gear device 22 to rotate the rearview mirror casing 26 relative to the car body 12 by a pivoting angle, the controller 16 can control the second gear device 24 to rotate the first monitoring device 20 by a compensation angle according to the pivoting angle of the rearview mirror casing 26. As such, the first monitoring device 20 can be driven to rotate correspondingly to be continuously aligned with the first surrounding area A₂ of the car body 12 even when the rearview mirror casing 26 is driven to rotate relative to the car body 12. For example, it is assumed that the user controls the first gear device 22 to rotate the rearview mirror casing 26 horizontally and outwardly by 5° relative to the car body 12 via the controller 16 for clearly viewing the situation behind the car 10. At this time, the first monitoring device 20 is misaligned with the first surrounding area A₂ since the first monitoring device 20 rotates horizontally and outwardly by 5° with rotation of the rearview mirror casing 26. Thus, the controller 16 controls the second gear device 24 to rotate the first monitoring device 20 horizontally and inwardly by 5° to keep the first monitoring device 20 continuously aligned with the first surrounding area A₂ for image surveillance. In such a manner, the present invention ensures that the user can still view the first surrounding area A₂ via the display monitor 30.

In practical application, the controller 16 could independently control rotation of the first monitoring device 20. That is to say, when the controller 16 independently controls the second gear device 24 to adjust the monitoring angle of the first monitoring device 20 relative to the first rearview mirror device 18, the first gear device 22 does not control the first rearview mirror device 18 to rotate. Accordingly, the present invention allows that the user can independently control rotation of the first monitoring device 20 to capture images toward a region of interest, so as to improve operational flexibility of the rearview mirror apparatus provided by the present invention.

In summary, the present invention adopts the design that the monitoring device is disposed on the rearview mirror casing and can be driven to rotate by a compensation angle according to the pivoting angle of the rearview mirror casing, so as to ensure that the display monitor can keep displaying the surveillance images of the blind spot area corresponding to the front window pillar of the car. In such a manner, since the present invention ensures that the user can view the images of the oblique rear area of the car and the images of the blind spot area corresponding to the front window pillar of the car simultaneously, the present invention can efficiently solve the prior art problem that there is no monitoring for the left or right surrounding area of the car, so as to greatly improve driving safety of the car.

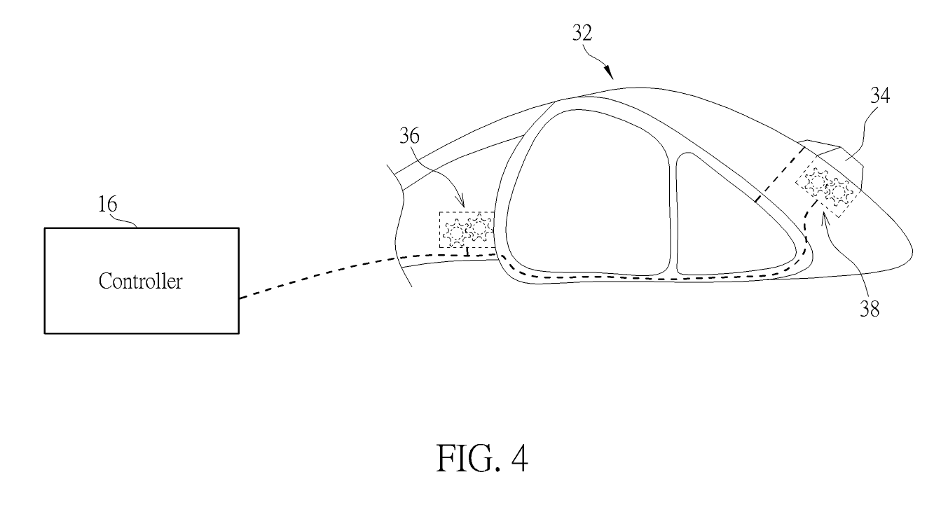

It should be mentioned that the aforesaid design could be further applied to monitoring a blind spot area corresponding to the second front window pillar P₂ away from the driving seat 13 for achieving the purpose that the left and right surrounding areas of the car can be both monitored. Please refer to FIG. 1, FIG. 2, and FIG. 4. FIG. 4 is an enlarged diagram of a second rearview mirror device 32 and a second monitoring device 34 in FIG. 1. As shown in FIG. 1, FIG. 2, and FIG. 4, the rearview mirror apparatus 14 could further include the second rearview mirror device 32, the second monitoring device 34, a third gear device 36, and a fourth gear device 38. The second rearview mirror device 32 is pivoted to a second lateral side S₂ of the car body 12, and the design of the second rearview mirror device 32 could be reasoned by analogy according to the design of the first rearview mirror device 18 and its related description is omitted herein. The third gear device 36 is connected to the second rearview mirror device 32 and is electrically connected to the controller 16 for driving the second rearview mirror device 32 to rotate relative to the car body 12. The second monitoring device 34 could be preferably an image capturing device (e.g. a surveillance camera) to be aligned with a second surrounding area A₃ of the car body 12 (preferably a blind spot area corresponding to the second front window pillar P₂) for image surveillance. The second monitoring device 34 is connected to the fourth gear device 38 so that the fourth gear device 38 can drive the second monitoring device 34 to rotate relative to the second rearview mirror device 32 for flexibly adjusting the monitoring angle of the second monitoring device 34.

In such a manner, when the controller 16 controls the third gear device 36 to rotate the second rearview mirror device 32 relative to the car body 12 by a pivoting angle, the controller 16 can control the fourth gear device 38 to rotate the second monitoring device 34 by a compensation angle according to the pivoting angle of the second rearview mirror device 32. As such, the second monitoring device 34 can be driven to rotate correspondingly to be continuously aligned with the second surrounding area A₃ of the car body 12 even when the second rearview mirror device 32 is driven to rotate relative to the car body 12.

Furthermore, the design of disposing the monitoring device on the rearview mirror device is not limited to the aforesaid embodiment. That is to say, all the designs may fall within the scope of the present invention, in which the monitoring device is disposed on the rearview mirror device to be aligned with the surrounding area of the car and the monitoring device can be driven to rotate correspondingly in a gear driving manner according to the pivoting angle of the rearview mirror device. For example, in another embodiment, the surrounding area could be a collision warning area of the car body and the monitoring device could be a distance sensor (e.g. an infrared light sensor or an ultrasound sensor) for monitoring the surrounding area of the car body, so as to help the user know whether the car body is too close to an object in the surrounding area according to a warning message (e.g. an alarm sound) provided by the monitoring device for efficiently preventing the crash accident. As for other related description for this embodiment (e.g. the gear driving design), it could be reasoned by analogy according to the aforesaid embodiment and omitted herein.

In addition, configuration of the monitoring devices is not limited to the aforesaid embodiment of disposing the two monitoring devices of the same type on the two rearview mirror devices respectively. That is to say, in another embodiment, the present invention can adopt the design of disposing two different types of monitoring devices on the two rearview mirror devices respectively to improve configuration flexibility and monitoring functionality of the rearview mirror apparatus provided by the present invention. For example, in another embodiment, the first monitoring device could be an image capturing device disposed on the first rearview mirror device to be aligned with the blind spot area corresponding to the first front window pillar for image surveillance, and the second monitoring device could be a distance sensor disposed on the second rearview mirror device to be aligned with the surrounding area of the car body for anti-collision monitoring. As for the related description for other derived embodiments (e.g. the embodiment of disposing the image capturing device and the distance sensor on the same rearview mirror device for performing image surveillance and anti-collision monitoring on the surrounding area of the car body), it could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rearview mirror apparatus for connecting to a car, the rearview mirror apparatus comprising:
a first rearview mirror device pivoted to a first lateral side of the car;
a first gear device connected to the first rearview mirror device for driving the first rearview mirror device to rotate relative to the car;
a first monitoring device pivoted to the first rearview mirror device for monitoring a first surrounding area of the car;
a second gear device connected to the first monitoring device for driving the first monitoring device to rotate relative to the first rearview mirror device; and
a controller electrically connected to the first gear device and the second gear device respectively, the controller controlling the second gear device to rotate the first monitoring device by a first compensation angle according to a first pivoting angle for aligning the first monitoring device with the first surrounding area when the controller controls the first gear device to rotate the first rearview mirror device by the first pivoting angle relative to the car.

2. The rearview mirror apparatus of claim 1, wherein the first surrounding area is a blind spot area corresponding to a front window pillar of the car, and the first monitoring device is an image capturing device for capturing images toward the blind spot area.

3. The rearview mirror apparatus of claim 2, wherein the first rearview mirror device comprises:
a rearview mirror casing pivoted to the first lateral side of the car and connected to the first gear device, the first gear device driving the rearview mirror casing to rotate relative to the car, the first monitoring device being pivotably disposed on the rearview mirror casing for aligning with the blind spot area;
a rearview mirror disposed in the rearview mirror casing for aligning with an oblique rear area of the car; and
a display monitor arranged alongside the rearview mirror to move together with the rearview mirror and the rearview mirror casing, the display monitor being electrically connected to the first monitoring device for displaying at least one image captured by the first monitoring device toward the blind spot area.

4. The rearview mirror apparatus of claim 1, wherein the first surrounding area is a collision warning area of the car, and the first monitoring device is a distance sensor to monitor the collision warning area for anti-collision monitoring.

5. The rearview mirror apparatus of claim 1 further comprising:
a second rearview mirror device pivoted to a second lateral side of the car;
a third gear device connected to the second rearview mirror device and electrically connected to the controller for driving the second rearview mirror device to rotate relative to the car;
a second monitoring device pivoted to the second rearview mirror device for monitoring a second surrounding area of the car; and
a fourth gear device connected to the second monitoring device and electrically connected to the controller for driving the second monitoring device to rotate relative to the second rearview mirror device;
wherein when the controller controls the third gear device to rotate the second rearview mirror device by a second pivoting angle relative to the car, the controller controls the fourth gear device to rotate the second monitoring device by a second compensation angle according to the second pivoting angle for aligning the second monitoring device with the second surrounding area.

6. The rearview mirror apparatus of claim 5, wherein the first surrounding area is a first blind spot area corresponding to a first front window pillar of the car, and the first monitoring device is an image capturing device for capturing images toward the first blind spot area.

7. The rearview mirror apparatus of claim 6, wherein the second surrounding area is a second blind spot area corresponding to a second front window pillar of the car, and the second monitoring device is an image capturing device for capturing images toward the second blind spot area.

8. The rearview mirror apparatus of claim 6, wherein the second surrounding area is a collision warning area of the car, and the second monitoring device is a distance sensor to monitor the collision warning area for anti-collision monitoring.

9. The rearview mirror apparatus of claim 1, wherein when the controller independently controls the second gear device to rotate the first monitoring device relative to the first rearview mirror device, the first gear device does not control the first rearview mirror device to rotate.

10. A car comprising:
a car body;
a rearview mirror apparatus connected to the car body, the rearview mirror apparatus comprising:
a rearview mirror device pivoted to a lateral side of the car body;
a first gear device connected to the rearview mirror device for driving the rearview mirror device to rotate relative to the car body;
a monitoring device pivoted to the rearview mirror device for monitoring a surrounding area of the car body; and
a second gear device connected to the monitoring device for driving the monitoring device to rotate relative to the rearview mirror device; and
a controller disposed in one of the car body and the rearview mirror apparatus and electrically connected to the first gear device and the second gear device respectively, the controller controlling the second gear device to rotate the monitoring device by a compensation angle according to a pivoting angle for aligning the monitoring device with the surrounding area when the controller controls the first gear device to rotate the rearview mirror device by the pivoting angle relative to the car body.

11. The car of claim 10, wherein the car body has a front window pillar, the first surrounding area is a blind spot area corresponding to the front window pillar, and the first monitoring device is an image capturing device for capturing images toward the blind spot area.

12. The car of claim 11, wherein the car body further has a driver seat, and the front window pillar is adjacent to the driver seat.

13. The car of claim 11, wherein the first rearview mirror device comprises:
a rearview mirror casing pivoted to the first lateral side of the car body and connected to the first gear device, the first gear device driving the rearview mirror casing to rotate relative to the car body, the first monitoring device being pivotably disposed on the rearview mirror casing for aligning with the blind spot area;
a rearview mirror disposed in the rearview mirror casing for aligning with an oblique rear area of the car body; and
a display monitor arranged alongside the rearview mirror to move together with the rearview mirror and the rearview mirror casing, the display monitor being electrically connected to the first monitoring device for displaying at least one image captured by the first monitoring device toward the blind spot area.

14. The car of claim 10, wherein the first surrounding area is a collision warning area of the car body, and the first monitoring device is a distance sensor to monitor the collision warning area for anti-collision monitoring.

15. The car of claim 10, wherein the rearview mirror apparatus further comprises:
a second rearview mirror device pivoted to a second lateral side of the car body;
a third gear device connected to the second rearview mirror device and electrically connected to the controller for driving the second rearview mirror device to rotate relative to the car body;
a second monitoring device pivoted to the second rearview mirror device for monitoring a second surrounding area of the car body; and
a fourth gear device connected to the second monitoring device and electrically connected to the controller for driving the second monitoring device to rotate relative to the second rearview mirror device;
wherein when the controller controls the third gear device to rotate the second rearview mirror device by a second pivoting angle relative to the car body, the controller controls the fourth gear device to rotate the second monitoring device by a second compensation angle according to the second pivoting angle for aligning the second monitoring device with the second surrounding area.

16. The car of claim 15, wherein the car body has a first front window pillar, the first surrounding area is a first blind spot area corresponding to the first front window pillar of the car body, and the first monitoring device is an image capturing device for capturing images toward the first blind spot area.

17. The car of claim 16, wherein the car body further has a second front window pillar, the second surrounding area is a second blind spot area corresponding to the second front window pillar of the car body, and the second monitoring device is an image capturing device for capturing images toward the second blind spot area.

18. The car of claim 17, wherein the car body further has a driver seat, and the second front window pillar is away from the driver seat.

19. The car of claim 16, wherein the second surrounding area is a collision warning area of the car body, and the second monitoring device is a distance sensor to monitor the collision warning area for anti-collision monitoring.

20. The car of claim 10, wherein when the controller independently controls the second gear device to rotate the first monitoring device relative to the first rearview mirror device, the first gear device does not control the first rearview mirror device to rotate.
